(19) United States
(12) Patent Application Publication
(10) Pub. No.: US 2002/0144383 A1
(43) Pub. Date: Oct. 10, 2002

(54) Vertical burial system

(76) Inventor: Edward R. Spence, Brighton, IL (US)

Correspondence Address: POLSTER, LIEDER, WOODRUFF & LUCCHESI, 763 SOUTH NEW BALLAS ROAD, ST. LOUIS, MO, 63141-8750, US

(21) Appl. No.: 09/829,540

(22) Filed: Apr. 9, 2001

(51) Int. Cl. A61G 17/00

(52) U.S. Cl. 27/35

(57) ABSTRACT

A vertical burial system is disclosed. The vertical burial system of the present invention comprises an outer, elongate chamber disposed substantially underground, and at least one burial capsule adapted to fit within the burial chamber. The burial chamber has a cover that is removable, so that as the need arises, additional burial capsules may be placed in the elongate burial chamber. The present invention thus simulates traditional burial, but conserves precious land by allowing multiple burials within the elongate burial chamber.

### CROSS REFERENCE TO RELATED APPLICATIONS

Not Applicable

### STATEMENT REGARDING FEDERALLY SPONSORED RESEARCH OR DEVELOPMENT

Not Applicable.

### BACKGROUND OF THE INVENTION

Land use and development has become an increasingly important aspect of modern civilization. As more land is required for a variety of reasons, innovative methods of utilizing the remaining land become essential. One traditional use of land is for the burial of the dead. However, traditional methods of burial or interment do not effectively utilize land. Other methods, such as cremation, while conservative with respect to land allocation, are sometimes unacceptable to individuals or their surviving loved ones for religious or other personal reasons.

Other solutions to the aforementioned land use problem have been suggested. For example, U.S. Pat. No. 5,381,591, issued to Ponger et al. on Jan. 17, 1995, discloses a multi-tier burial system comprising a plurality of precast elements, a first plurality of the elements being aligned to form a first tier defining a plurality of spaced-apart burial niches, and a second plurality of the elements being aligned to form a second tier supported by the first tier also defining a plurality of spaced-apart burial niches, the niches in the second tier being vertically staggered in relation to the niches in the first tier. This solution still requires a substantial area for burial, and situates distinct burial sites in a group of potentially unrelated individuals.

### BRIEF SUMMARY OF THE INVENTION

In accordance with the present invention, a vertical burial system is disclosed. The vertical burial system of the present invention comprises an outer, elongate chamber disposed substantially underground, and at least one burial capsule adapted to fit within the burial chamber. The burial chamber has a cover that is removable, so that as the need arises, additional burial capsules may be placed in the elongate burial chamber. The present invention thus simulates traditional burial, but conserves precious land by allowing multiple burials within the elongate burial chamber. The burial system of the present invention is particularly well suited for grouping families or relatives within a discrete burial site.

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1 is a cross sectional view of an elongate burial chamber of the present invention;

FIG. 2 is a side elevational view of a burial capsule of the present invention;

FIG. 3 is a cross sectional view of ground prepared to receive an elongate burial chamber of the present invention;

FIG. 4 is a cross sectional view of an elongate burial chamber of the present invention disposed in the ground with a single burial capsule;

FIG. 5 is a cross sectional view of an elongate burial chamber of the present invention disposed in the ground with multiple burial capsules;

FIG. 6 is a side view of a burial capsule of the present invention;

FIG. 7 is a top plan view of a burial capsule of the present invention;

FIG. 8 is a front plan view of a burial capsule of the present invention;

FIG. 9 is top plan view of an array of burial chambers of the present invention; and

FIG. 10 is a side elevational view of an array of burial chambers of the present invention.

Corresponding reference characters indicate corresponding parts throughout the several views of the drawings.

### DETAILED DESCRIPTION OF INVENTION

Referring to the drawings, and in particular to FIG. 1, a vertical burial system of the present invention has an elongate, outer burial chamber 1 comprising an elongate chamber portion 3 and a cover 11. The elongate chamber portion 3 is defined by an inner wall 5 and an outer wall 7. The cap 11 has an upper end 13 and a lower end 15. Near the top of the chamber portion 3, internal threads 6 are adapted to receive the external threads 16 of the bottom end 15 of cap 11. In the preferred embodiment of the present invention, an opening 19 extends from the upper end 13 through the lower end 15 of the cap 11. A vent tube 21 is disposed toward the upper end 13 of the cap 11, and preferably extends a distance above the upper end 13 of the cap 11. In an especially preferred embodiment, a carbon filter 23 is situated within the vent tube 21. The lower end 24 of the vent tube 21 extends a distance into the opening 19, and preferably extends completely through the opening 19 and the lower end 15 of the cap 11.

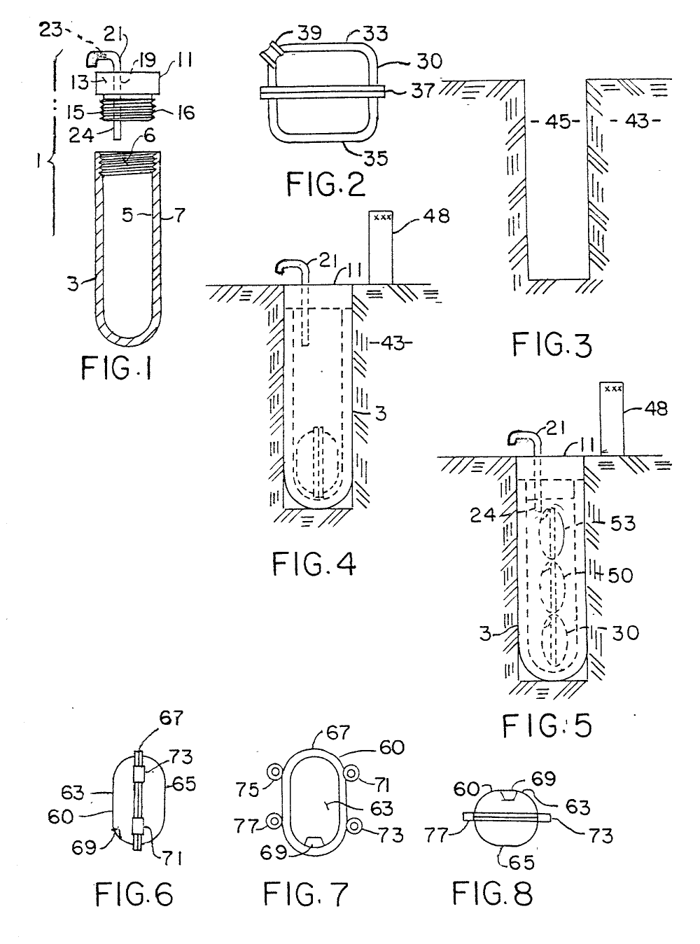

Referring now to FIG. 2, a burial capsule of the present invention is generally shown at 30. The length and width of the burial capsule 30 is determined by the remains of the deceased to be buried, so that the burial capsule may configured to hold the body of an adult, or a smaller version may be required to hold the body of a child. Preferably, the length of the burial capsule will be that length sufficient to hold a body in an extended, supine position. In the preferred embodiment of the present invention, the burial capsule 30 is formed as a clamshell, with an upper portion 33 and a lower portion 35. In the closed position of burial capsule 30, the upper portion 33 meets the lower portion 35 at seam 37. In the preferred embodiment of the present invention, a vent 39 allows gasses evolved during decomposition of a corpse to be released from the interior of the capsule 30. In an especially preferred embodiment of the burial capsule 30, the vent 39 allows gasses to escape without admitting gasses from the exterior of the capsule 30. The burial capsule 30 may be fabricated in a number of colors, depending upon the wishes of the deceased or the family of the deceased.

Referring now to FIG. 3, a prepared site for a burial system of the present invention is shown. The ground 43 may be prepared by digging, blasting, boring with an auger, or other effective means of creating an opening 45 in the ground 43. The opening 45 should of course be sufficient to allow the outer surface 7 of the elongate chamber 3 to be placed within the opening's confines.

Referring now to FIG. 4, a burial capsule 30 is shown inside the elongate chamber 3. As gasses are evolved during decomposition of a corpse inside the burial capsule, those gasses escape through the vent 39 into the elongate chamber portion 3, and finally into the atmosphere through the vent tube 21 in the cap 11. A monument or headstone 48 may be installed at or near the burial system. Optionally, the monument 48 may partially obscure the vent 21, and in this regard, the monument 48 may additionally be fabricated to accommodate a portion of the vent 21, for further concealment, such as with, for example, a cavity (not shown) formed within monument 48 for partially concealing vent 21.

Referring to FIG. 5, a plurality of burial capsules 30, 50 and 53 are shown disposed inside the elongate chamber 3. As can be seen from this illustrative embodiment, the lower end 24 of vent tube 21 is spaced a distance from the uppermost burial capsule 53. It is to be understood that more than the illustrative number of burial capsules may be disposed in the elongate chamber 3 in the practice of the present invention, and that a corresponding adjustment to the length of elongate chamber 3 enables a larger or smaller number of burial capsules to be so disposed. Furthermore, the size of one or more burial capsules may be different within a single elongate chamber.

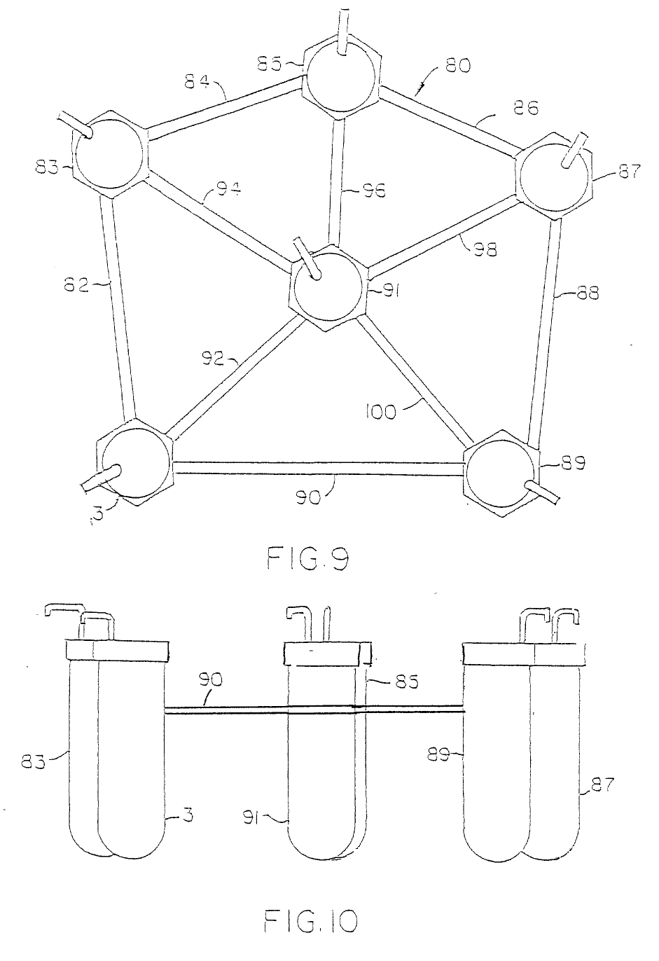

Referring now to FIGS. 6-8, and alternative embodiment of a burial capsule 60 is shown. Burial capsule 60 is preferably formed in two cooperating portions, and therefore has a top portion 63, a bottom portion 65, and a center seam 67. Center seam 67 is the point of closure for the top portion 63 and the bottom portion 65. Center seam may be hinged on one side, such that top the portion 63 and the bottom portion 65 are attached, or alternatively the top portion 63 and the bottom portion 65 may be separate pieces. Preferably, a vent 69 is disposed in either the top portion 63 or the bottom portion 65 of the burial capsule 60. The vent 69 allows gasses evolved during decomposition of a corpse to be released from the interior of the capsule 60. Of course, the burial capsule 60 may be formed without the vent 69, and may be fabricated from a gas permeable material, or have holes incorporated for release of gasses. Furthermore, the burial capsule 60 may alternatively have no accommodation for evolved gasses, and may be sealed, for example.

In this alternative embodiment of a burial capsule or the present invention, plurality of rings 71, 73, 75, and 77 are formed in or near the center seam 67 of the burial capsule 60. The rings 71, 73, 75, and 77 provide convenient attachment points for raising or lowering the burial capsule 60 into an elongate chamber of the present invention. Additionally, the rings 71, 73, 75, and 77 may be used for carrying the burial capsule 60 from a funeral home, for example, to the burial site. It will be appreciated by those skilled in the art that the rings 71, 73, 75, and 77 may be oriented either parallel to the plane defined by the longitudinal axis of the center seam 67 of the burial capsule 60, or at an angle or transverse to the plane defined by the longitudinal axis of the center seam 67. Alternatively, the rings may swivel, such that in one orientation, the rings are parallel to the plane defined by the longitudinal axis of the center seam 67 of the burial capsule 60, for example, and movable into a position transverse to the plane defined by the longitudinal axis of the center seam 67. In this embodiment, when the rings are placed in their parallel orientation, a rod (not shown) may be placed through the rings on each side of the burial capsule 60 for carrying the burial capsule 60 to a destination, for example to the elongate chamber. Once at the destination, one or all of the rings may then be moved into the transverse position, for receiving a hook, for example, for lowering the capsule 60 into an elongate burial chamber 3.

Referring now to FIGS. 9 and 10, a burial complex 80 comprises a plurality of interconnected burial systems 3, 83, 85, 87, 89, and 91. The burial systems 3, 83, 85, 87, 89, and 91 are preferably interconnected by beams 82, 84, 86, 88, and 90, respectively. The beams 82, 84, 86, 88, and 90 are preferably attached to respective burial systems 3, 83, 85, 87, 89, and 91 at a point below the respective caps, for example. Preferably, a second set of beams, 92, 94, 96, 98, and 100 interconnect burial systems 3, 83, 85, 87, 89 with burial system 91. It is to be understood that any number of burial systems may be interconnected with corresponding beams, and the illustrative example of six burial systems is not intended to be limiting. Beams 82, 84, 86, 88, and 90, along with beams, 92, 94, 96, 98, and 100 provide a strong, stable interconnection between burial systems 3, 83, 85, 87, 89, and 91. Alternatively, the beams may be pre-attached one to another, such that a frame is established. The frame may have round members at the remote ends of the beams, and the round members may have openings therein, for receiving respective elongate chambers.

It is contemplated by the present invention that locations previously considered too inhospitable for traditional burial, such as areas with highly water saturated earth, for example may be used for burial utilizing the burial complex 80. It is also contemplated by the present invention that one or more burial systems in the burial complex 80 may have weights or other anchoring devices for stabilizing the burial complex 80 in such environments.

Numerous variations will occur to those skilled in the art in light of the foregoing disclosure. For example, a traditional coffin may be temporarily used to carry a burial capsule from a funeral facility to a burial facility. The elongate burial chamber may be made from a variety of materials. The elongate burial chamber may be made in a shape other that the illustrative generally cylindrical form. The cap of the elongate burial chamber may optionally omit a vent, and the elongate burial chamber may be made of a gas permeable material, have holes, or make no provision at all for gasses evolved during the decomposition of a corpse disposed therein. The burial capsule may also be fabricated from a variety of materials. These are merely illustrative.

Having thus described the invention, what is claimed and desired to be secured by Letters Patent is:

1. A vertical burial system comprising:
an elongate outer chamber, said elongate outer chamber substantially buried under ground;
a cap having an upper end and a lower end, said cap substantially covering said elongate outer chamber; and
at least one burial capsule sized to fit within said elongate outer burial chamber.

2. The vertical burial system of claim 1 wherein said cap further includes a vent, said vent passing through said cap from said lower end of said cap through said upper end of said cap.

3. The vertical burial system of claim 2 wherein said vent in said cap further includes a carbon filter.

4. The vertical burial system of claim 1 wherein a plurality of burial capsules are disposed within said elongate outer chamber.

5. The vertical burial system of claim 1 wherein said burial capsule is made from a colored plastic material.

6. A burial complex comprising:
a plurality of burial systems, said burial systems each comprising an elongate outer chamber, each of said elongate outer chambers having caps substantially covering respective elongate outer chambers, at least one of said elongate outer chambers having a burial capsule disposed therein, said burial systems interconnected through a plurality of beams.

7. The burial complex of claim 6 wherein said beams interconnect said burial systems at a point below the burial system's respective caps.
